(19) United States
(12) Patent Application Publication
(10) Pub. No.: US 2012/0137837 A1
(43) Pub. Date: Jun. 7, 2012

(54) BOLT-NUT TURNING MULTI SOCKET

(76) Inventor: Masaaki SOUMA, Haga-gun (JP)

(21) Appl. No.: 13/305,723

(22) Filed: Nov. 28, 2011

(30) Foreign Application Priority Data
Dec. 1, 2010 (JP) 2010-267993

(51) Int. Cl. B25B 13/06; B25B 23/02

(52) U.S. Cl. 81/124.3; 81/124.5

(57) ABSTRACT

The present invention relates to the compact multi socket capable of turning a plurality of bolts or nuts having different diameters by one tool.

The outer socket A at the upper part is provided with the handle connecting hole 1, the installed inner socket C and the coil spring 26 installed between the outer socket A and the inner socket C so as to bias the inner socket in a direction for pushing out the inner socket from the outer socket A. The outer socket A, the polygonal sliding inner peripheral surface 4 having the large holding part 5 is formed from the opening part to a part near the intermediate part, the sliding inner peripheral surface 31 is formed at the intermediate part, and a ring sliding inner peripheral surface 17 is formed from a part near the intermediate part to the upper part.

### TECHNICAL FIELD OF THE INVENTION

This invention relates to a bolt-nut turning socket for use in fastening and loosening bolts or nuts.

### BACKGROUND OF THE INVENTION

There has been provided a socket as a prior art such as a torque wrench or a ratchet wrench or the like for use in screw fastening work in which bolts or nuts having different diameters can be processed with one tool.

For example, in regard to two-step type socket capable of adapting for two types of bolts or nuts having different diameters, there have been provided one proposal of a multi socket for a wrench described in the Patent Document 1 as mentioned below, wherein an outer cylinder formed with a second hexagonal hole biased by a spring is fitted on the outside of an inner cylinder formed with a first hexagonal hole in such a way that the outer cylinder can be axially slid. And the other proposal of “a socket for tool” described in the Patent Document 2 as mentioned below, wherein a socket is installed in a socket main body in such a way that the former can be protruded out of or sunk into the latter.

Additionally, in regard to a three-step type socket that can be adapted for bolts or nuts having three different diameters, there has been provided a proposal of “a nut fastening unit” described in the Patent Document 3 as mentioned below, wherein each of three rectangular cylinders that can be slid and protruded out or sunk to each other is protruded at its extremity end and a spring is installed at the rear end portion of the rectangular cylinder, respectively.

### RELATED ART

Related Patent Documents on this invention are described as follows:

Patent Document 1: Japan Utility Model unexamined Publication No. Hei-7 (1995)-20259-A

Patent Document 2: Japan Patent Unexamined Publication No. 2010-131726

Patent Document 3: Japan Utility Model Unexamined Publication No. Sho-10(1935)-5726

Although the invention described in the aforesaid Patent Document 1 is defined as a multi type socket, it is constituted in such a way that a first hexagonal hole of the inner cylinder and a second hexagonal hole of the outer cylinder are applied as two sockets and a unit with more than three steps is not disclosed in it and so it is not possible to attain three sockets through an addition of another one more socket merely.

In addition, since the spring for sliding the outer cylinder is exposed at an outer upper part of the inner cylinder, it is not possible for a worker to hold the socket itself to perform a fastening work for the bolts or nuts, so that the worker must connect a handle to the socket without fail and use it. Due to this fact, a handle of the tool hinders a worker in a narrow space from fixing work for bolts or nuts at an assembling factory, resulting in that this may become a cause for reducing a working efficiency.

The invention described in the aforesaid Patent Document 2 is merely comprised of two sockets, i.e., a socket main body and an inner socket, so that even if it is tried to add one more inner socket to them to get a unit of three sockets, it is not possible to get easily a system of three sockets because a structure of socket installed as an intermediate one must be made under a structure that is quite different from the structures of the socket main body and the inner socket. In addition, in the case that another one more socket is set as an intermediate one to get a unit of three sockets, the abutting surface of a step part for use in determining an inserting position of the inner socket must be loosened and made small, so that the socket is fitted on deeper into the unit at the step part and there occurs a possibility that the inner socket is fitted on the socket main body and is not easily pulled out of it.

The invention described in the aforesaid Patent Document 3 shows a disadvantage that a supporting of the cylinders becomes unstable to each other because they protrude much, resulting in that the bolts or the like cannot be fastened hard and in the case that the rectangular cylinder is thin in its size, it is hard to get a sufficient strength capable of enduring its use. Further, it is not possible to make its entire length short and compact because a protruding length of the extremity end of the rectangular cylinder is correspondingly long.

The multi socket described in these Patent Documents had a difficulty of assuring strength at its fastening part because the inner socket must have a thin wall thickness in the case that the bolts or nuts used show a small difference in their sizes.

It is an object of this invention to provide bolt-nut turning multi socket having a compact structure in which a strength of an inner socket stored in it and having a restricted thin wall thickness for a small diameter component can be assured, and both a fastening work and a loosening work can be carried out smoothly by one tool for bolts or nuts with different diameters up to three types and further both fastening and loosening can be carried out even if no handle is installed at the sockets.

### DISCLOSURE OF THE INVENTION

In order to solve the aforesaid problem, the bolt-nut turning multi socket of this invention in Claim 1 comprise,

a cylindrical hanging-bell shaped outer socket having a handle connecting part and/or an anti-slip irregular surface around an outer side surface formed at an upper part,

combining a cylindrical hanging-bell shaped inner socket that is stored in the outer socket; or

combining the cylindrical hanging-bell shaped inner socket is stored in a cylindrical hanging-bell shaped intermediate socket which are stored in the outer socket.

Then, a coil spring for biasing each of the stored sockets in its pushing-out direction out of the outer socket is installed between the outer socket and the inner socket,

or between the outer socket and the intermediate socket and between the outer socket and inner socket.

The inner space of the outer socket, a polygonal sliding inner peripheral surface having a polygonal cylindrical large holding part at an opening end side to which a large-sized bolt head or nut can be fitted on is formed from the opening part to a part near the intermediate part, the sliding inner peripheral surface having the same diameter or drawn to a smaller diameter than that of an inscribed circle line of the polygonal sliding inner peripheral surface is formed at the intermediate part and a ring sliding inner peripheral surface having a larger diameter than that of the sliding inner peripheral surface is formed from a part near the intermediate part to the upper part, and a horizontal downward facing stopper is formed at the upper part.

At the outer peripheral surface of the intermediate socket, a polygonal sliding outer peripheral surface that is slidably inscribed with the polygonal sliding inner peripheral surface in the outer side socket is formed from the lower part to the intermediate part, the sliding outer peripheral surface that is slidably inscribed with the sliding inner peripheral surface of the outer socket is formed from the intermediate part to the upper part, a C-shaped sliding ring having a ring fitting circle-cercumferencial groove arranged at the upper part and slidably abutted against the ring sliding inner peripheral surface of the outer socket is fitted on the ring fitting circle-cercumferencial groove and at the same time a horizontal upward facing stopper oppositely facing against the downward facing stopper of the outer socket is formed.

The inner space of the intermediate socket, the polygonal sliding inner peripheral surface having a polygonal cylindrical intermediate holding part at the opening end side to which a medium-sized bolt head or nut can be fitted on is formed from the opening part to a part near the intermediate part, a sliding inner peripheral surface having the same diameter or drawn to a smaller diameter than that of an inscribed circle line of the polygonal sliding inner peripheral surface is formed at the intermediate part and the ring sliding inner peripheral surface having a larger diameter than that of the sliding inner peripheral surface is formed from a part near the intermediate part to the upper part, a spring insertion through-pass hole is passed through and arranged at the upper part, and the horizontal upward facing stopper is formed.

At the outer peripheral surface of the inner socket, a polygonal sliding outer peripheral surface that is slidably inscribed with the polygonal sliding inner peripheral surface in the outer side socket is formed from the lower part to the intermediate part, the sliding outer peripheral surface that is slidably inscribed with the sliding inner peripheral surface of the outer side socket is formed from the intermediate part to the upper part, a C-shaped sliding ring having the ring fitting circle-cercumferencial groove arranged at the upper part and slidably abutted against the ring sliding inner peripheral surface of the outer side socket is fitted on the ring fitting circle-cercumferencial groove and at the same time the horizontal upward facing stopper oppositely facing against the downward facing stopper of the outer side socket is formed.

The inner space of the inner socket, a polygonal cylindrical small holding part to which a small-sized bolt head or nut can be fitted on is formed from the opening end to the intermediate part, and a bolt-screw releasing space having the same diameter as or drawn to a smaller diameter than that of an inscribed circle line of the small holding part is formed from the intermediate part to the upper part. [symbol] peripheral shape of each size of the bolt head or nut, according to Claim 2, wherein

the large holding part of the outer socket combines into,

a) the small holding part of the inner socket in respect to the large holding part of the outer socket; or

b) the intermediate holding part of the intermediate socket in respect to the large holding part of the outer socket, and the small holding part of the inner socket in respect to the intermediate holding part of the intermediate socket;

are formed at a position where a phase is shifted in such a direction as one where a contacted position of the bolt head or nut has a wall thickness when the outer socket is turned in a fastening direction from a position where relative phase difference is zero.

The bolt-nut turning multi socket according to Claim 3 or Claim 4, wherein the tapered steps are formed at the upper and lower end parts of the sliding inner peripheral surface in each of the socket except the inner socket, and a tool insertion through-pass hole is arranged at the upper central part of the outer socket having such a caliber in which a tool can be inserted and be passed through.

In the case of two sockets under a combination of the outer socket and the inner socket of this invention, the inner socket can be applied as it is in respect to a small-sized bolt head or nut to be fitted on the small holding part, and the outer socket can be applied through insertion of the inner socket into the outer socket in respect to a large-sized bolt head or nut to be fitted on the large holding part.

Further, in the case of three sockets including the intermediate socket, the inner socket can be applied as it is in respect to the small-sized bolt head or nut to be fitted on the small holding part,

the intermediate socket can be applied through insertion of the inner socket into the intermediate socket in respect to the medium-sized bolt head or nut to be fitted on the intermediate holding part,

also, the outer socket, the system can be used while the intermediate socket and the inner socket are sunk into the large holding part of the outer socket in respect to the large-sized bolt head or nut.

That is, this invention of one size can be used for fastening or loosening against the bolt heads or nuts of large and small sizes, or large, medium and small sizes, respectively.

In addition, the extremity end openings of the outer socket, the intermediate socket and the inner socket are set in flush with each other when this invention is used, the inner side socket having a relative thin and weak wall thickness is protected by the outer socket and its long life is assured without any damage, both the form of two sockets and/or the form of three sockets can be manufactured under an entire light weight and compact size because the outer socket can be formed to a minimum length.

Thus, in the case that the anti-slip irregular surface is formed around the outer peripheral surface at the outer socket, the anti-slip irregular surface is gripped with a hand, the bolt head or nut can be slightly fastened of without any handle. By using a handle, the user can work efficiently in a narrow space where the handle does not hinder and the user can move freely.

So that it becomes possible small power to perform a strong fastening of the bolt head or nut if the handle is installed at the handle connecting part of the upper part of the outer socket.

The outside part of the inner side socket can be sunk and stopped at its specified position positively by the downward facing stopper and the upward facing stopper horizontally faced to each other without causing the outside part of the inner side socket to be strongly fitted on the inside part of the outer side socket.

Due to this fact, it becomes possible to eliminate some disadvantages that a hard returning of the sockets under their severe fitting even if a pushing force of the coil spring is applied and a damage of the part where the steps are abutted.

In the case of the invention described in Claim 2, the large holding part, the intermediate holding part and the small holding part having polygonal cylindrical shape corresponding to the polygonal outer peripheral shape of the each size of the bolt heads or nuts, are formed at a position where a phase is shifted in such a direction as one where the contacted position of the bolt heads or nuts has the wall thickness, when the outer socket is turned in the fastening direction from the position where relative phase difference is zero, the eccentric wall thickness portion is formed at the holding part, the strength of the holding parts to which the high pressure applied to the corner portions of the bolt heads or nuts is increased and the entire holding part can endure against the high pressure received from the bolt heads or nuts even if its wall thickness is thin.

Additionally, as a result of increasing in strength of each of the holding parts, a size of each of the holding parts for use in holding the bolt heads or nuts up to three types of different size can be formed under a smaller range.

In the case of the invention described in Claim 3 and Claim 4, the tool is inserted into the outer socket through the tool insertion through-pass hole to push out the stored socket strongly, thereby the C-shaped sliding ring fitted on the ring fitting circle-cercumferencial groove can easily move through the tapered steps are formed at the upper end part of the sliding inner peripheral surfaces of the outer side sockets while its diameter is being drawn, and it becomes possible to separate each of the sockets in an easy manner as the C-shaped sliding ring can be passed through the sliding inner peripheral surface.

Additionally, to the contrary, when the inner side socket is installed into the outer side socket with its hard pushing the inner side socket into the outer side socket, the C-shaped sliding ring can easily move through the tapered steps are formed at the lower end of the sliding inner peripheral surfaces of the outer side sockets while its diameter is being drawn.

Then, after the C-shaped sliding rings fitted on the ring fitting circle-cercumferencial grooves have passed through the sliding inner peripheral surfaces, it is recovered and slidably abutted against each of the sliding inner peripheral surfaces, thereby a stable protrusion or sinking of each of the sockets can be attained.

Further, since the intermediate socket has a spring insertion through-pass hole at its upper part, separation of all members can be easily carried out if a coil spring is removed after the inner socket is removed from the outer socket, and the tool is strongly inserted at the spring insertion through-pass hole.

### BRIEF DESCRIPTION OF THE DRAWINGS

FIG. 1 is a side view of longitudinal cross section for showing a form corresponding to two sizes of bolt heads or nuts and a state in which a small holding part can be used.

FIG. 2 is a perspective view of longitudinal cross section for showing parts of a form corresponding to three sizes of bolt heads or nuts are separated.

FIG. 3 is a flat view for showing an inscribed circle line of a bolt head or a nut corner part as seen from an opening side of a form corresponding to three sizes of the bolt heads or nuts.

FIG. 4 is a flat view as seen from an opened side of a form corresponding to three sizes of the bolt heads or nuts.

FIG. 5 is a side view of longitudinal cross section for showing a state in which the small holding part in a form in FIG. 2 is used.

FIG. 6 is a side view of longitudinal cross section for showing a state in which the intermediate holding part in a form of FIG. 2 is used.

FIG. 7 is a side view of longitudinal cross section for showing a state in which the large holding part in a form in FIG. 2 is used.

FIG. 8 is a side view of longitudinal cross section for showing a state in which the small holding part in a form in FIG. 2 is using.

FIG. 9 is a side view of longitudinal cross section for showing a state in which the intermediate holding part in a form in FIG. 2 is using.

FIG. 10 is a side view of longitudinal cross section for showing a state in which the large holding part in a form in FIG. 2 is using.

### BEST MODE FOR CARRYING OUT THE INVENTION

A form of the bolt-nut turning multi socket of this invention will be described as follows:

This invention is made such that a handle connecting part and/or an anti-slip irregular surface around the outer side surface is formed at the upper part of the cylindrical hanging-bell shaped outer socket.

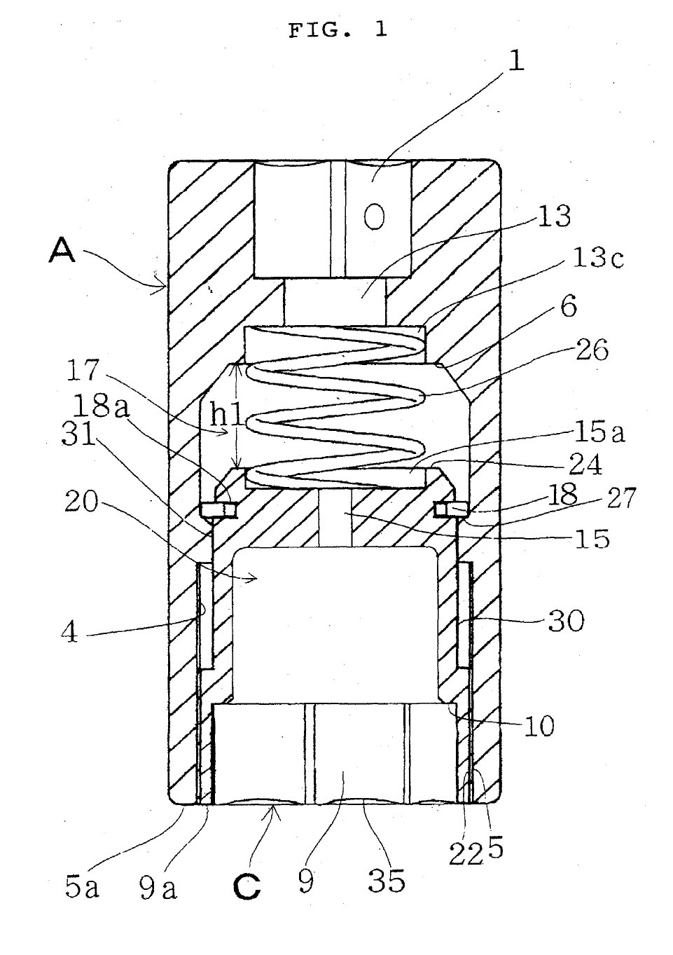

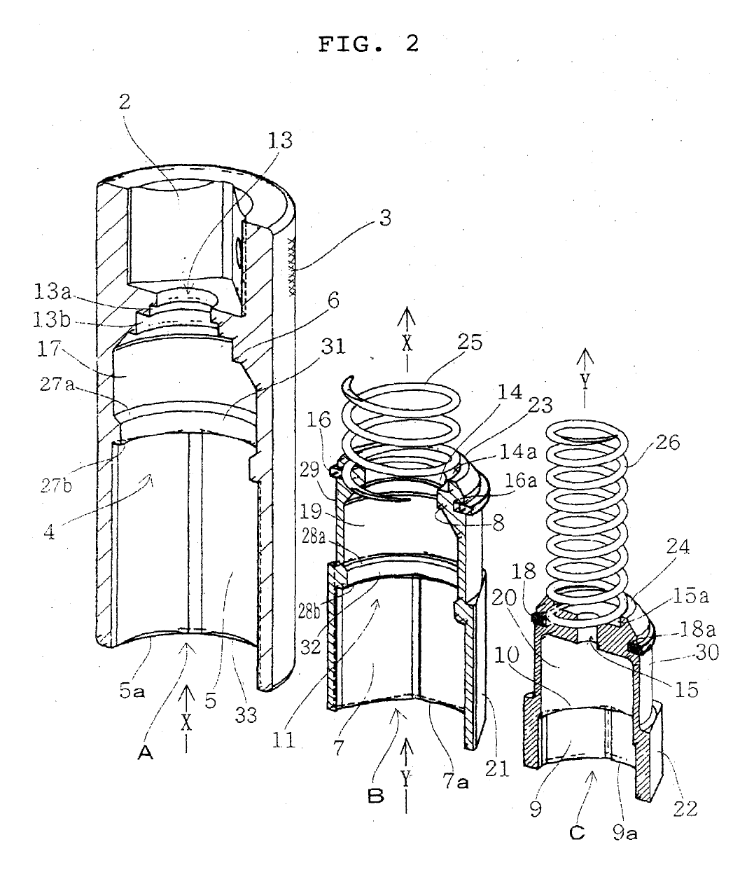

As to the handle connecting part, there can be provided two forms of a small handle connecting hole 1 formed at the upper part of the outer socket A as shown in FIG. 1 and a large handle connecting hole 2 formed at the upper part of the outer socket A as shown in FIG. 2.

In addition, as shown in FIG. 2, as the anti-slip irregular surface 3 of the outer socket A, various types of irregular surfaces such as net-like shapes or many parallel vertical lines can be formed.

Further, for a connecting structure of the handle connecting part, a bolt connecting form or other various types can be applied.

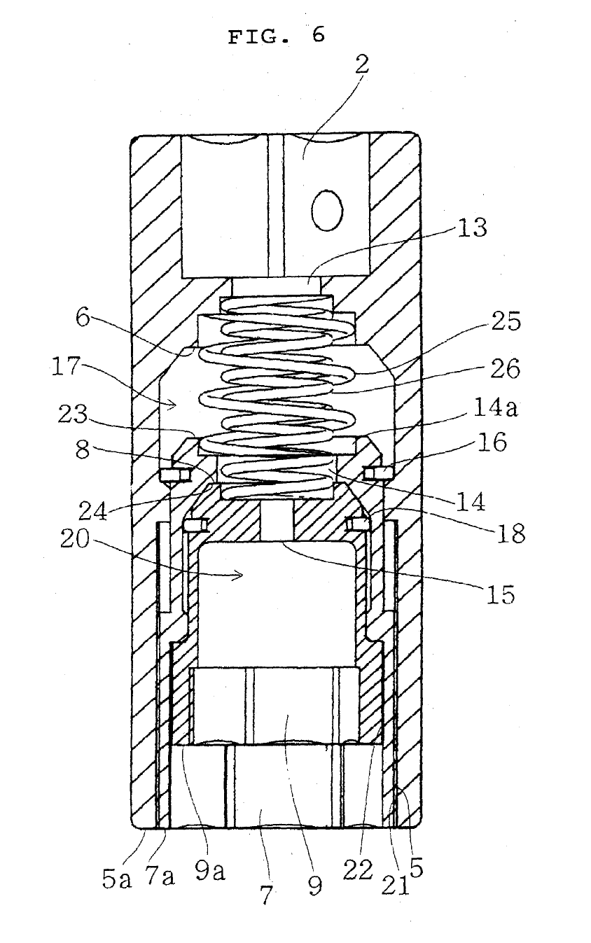

It is possible to employ two sockets as shown in FIG. 1 or three sockets as shown in FIG. 5 in response to a size of each of the bolt heads or nuts to be used.

Although a shape of each of the bolt heads or nuts in the preferred embodiment is a hexagonal shape, it is possible to employ an octagonal shape and the like corresponding to various shapes.

Then, a form of two sockets will be described as follows:

As shown in FIG. 1, the inner socket C which is smaller than the outer socket A and is stored inside the outer.

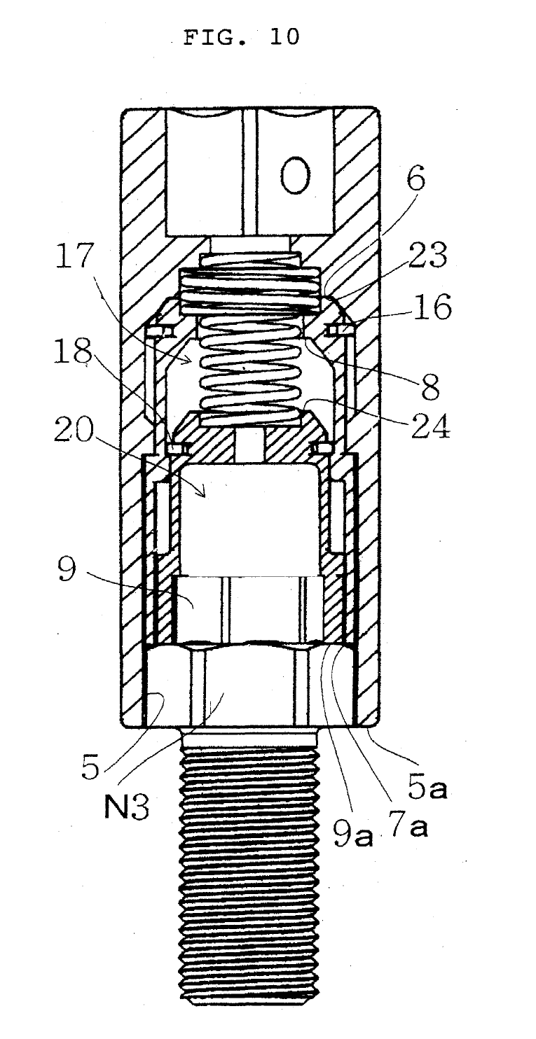

The form of the two sockets is used for turning two types of sizes, i.e., a large bolt head N3 shown in FIG. 10 and a small-sized bolt head N1 shown in FIG. 8.

The outer socket A forms a cylindrical hanging-bell shape. FIG. 1 shows, a form in which the handle connecting hole 1 at the upper part is provided. Thus, the anti-slip irregular surface 3 (refer to a portion denoted by a reference number 3 in FIG. 2) is formed around the outer side surface at the upper part.

Then, as shown in FIG. 1, the entire bolt-nut turning multi socket of this invention are constituted by the outer socket A, the cylindrical hanging-bell shaped inner socket C stored in the outer socket A and the coil spring 26 is installed between the outer socket A and the inner socket C so as to bias the inner socket C in a direction for pushing out the inner socket C from the outer socket A.

The outer socket A has its inner space ranging from the opened lower part to the closed upper part with the cylindrical hanging-bell shape.

In the inner space, the polygonal sliding inner peripheral surface 4 having the polygonal cylindrical large holding part 5 at the opening end 5a side to which the large-sized bolt head or nut can be fitted on is formed from the opening part to the part near the intermediate part, the sliding inner peripheral surface 31 having the same diameter or drawn to the smaller diameter than that of the inscribed circle line-R of the polygonal sliding inner peripheral surface 4 is formed at the intermediate part, and the ring sliding inner peripheral surface 17 having the larger diameter than that of the sliding inner peripheral surface 31 is formed from the part near the intermediate part to the upper part.

In addition, the sliding inner peripheral surface 31 protrudes into a space in the socket, and tapered steps 27a, 27b are formed at its upper and lower end parts.

At the outer peripheral surface of the inner socket C, the polygonal sliding outer peripheral surface 22 that is slidably inscribed with the polygonal sliding inner peripheral surface 4 in the outer socket A is formed from the lower part to the intermediate part, the sliding outer peripheral surface 30 that is slidably inscribed with the sliding inner peripheral surface 31 of the outer socket A is formed from the intermediate part to the upper part.

Accordingly, a step is formed at an interface between the polygonal sliding outer peripheral surface 22 and the sliding outer peripheral surface 30 of which diameter is smaller than one of the former.

At the upper part of the inner socket C, the ring fitting circle-cercumferencial groove 18a is arranged, and the C-shaped sliding ring 18 slidably abutted against the ring sliding inner peripheral surface 17 of the outer socket A is fitted on the ring fitting circle-cercumferencial groove 18a.

Then, when the C-shaped sliding ring 18 slidably abutted against the ring sliding inner peripheral surface 17 is fitted on and stopped at its lower limit part against the tapered step 27a, the opening end 5a at the extremity end of the outer socket A and the opening end 9a at the extremity end of the inner socket C are arranged in flush with each other.

In addition, the inner space of the intermediate socket C, the polygonal cylindrical small holding part 9 to which a small-sized bolt head or nut can be fitted on is formed from the opening end to the intermediate part, and the bolt-screw releasing space 20 having the same diameter as or drawn to a smaller diameter than that of the inscribed circle line of the small holding part 9 is formed from the intermediate part to the upper part.

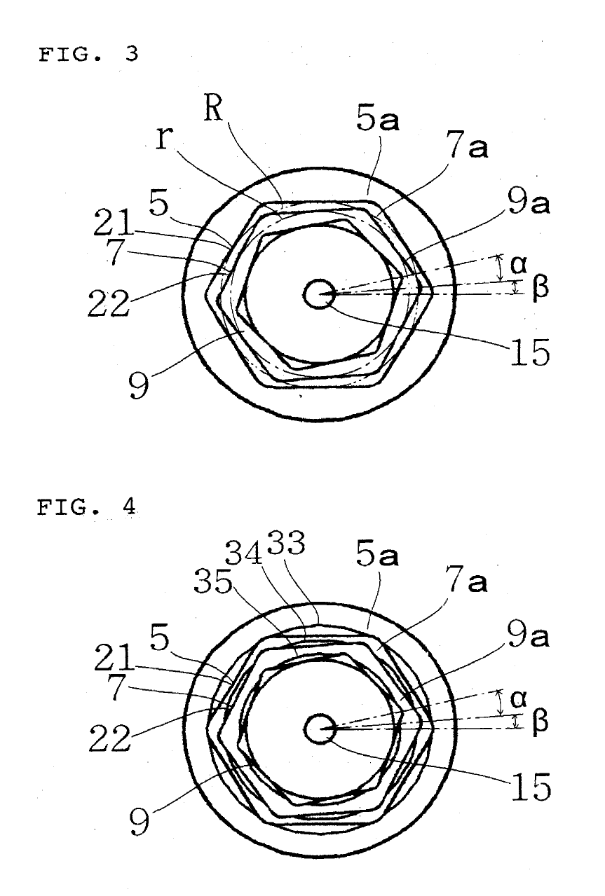

As shown in FIG. 3, the inscribed circle line is defined as a circle line inscribed with a planer surface equally formed in the polygonal sliding inner peripheral surface 4 or the small holding part 9 within the socket such as the outer socket A or the inner socket C and the like.

For example, in FIG. 3, it is expressed with a two-dotted line of true circle in which the inscribed circle line-R is inscribed with each of the surfaces equally formed like the polygonal sliding inner peripheral surface 4 of the outer socket A.

Each of oppositely facing the downward facing stopper 6 at the upper part of the inner space of the outer socket A and the upward facing stopper 24 at the upper part of the outer peripheral surface of the inner socket C, respectively formed. When a space between the downward facing stopper 6 and the upward facing stopper 24 is narrow and small, the large holding part 5 for holding the bolt head or nut is made shallow, resulting in that it is not preferable because when the unit is used, the bolt head or nut may easily be released. Forming a space hl between the downward facing stopper 6 and the upward facing stopper 24 to the same size as a height of the bolt head or nut applied as an item to be used is preferable for making a sufficient holding and hard fastening of the bolt head or nut with the large holding part 5 so as to push it.

At an interface between the bolt-screw releasing space 20 and the small holding part 9 is formed the bolt-nut stopper 10 where the set bolt head or nut abut against it and stop there. Forming a height position of the bolt-nut stopper 10 from the opening end 9a to the same height as that of the bolt head or nut to be used is preferable for making a sufficient hold and strong fastening of the bolt head or nut with the small holding part 9 and the large holding part 5.

Although the bolt-screw releasing space 20 is formed to the same diameter or drawn a smaller diameter than that of the inscribed circle line of the small holding part 9, it is preferable that its diameter is set to the same diameter as that of the inscribed circle line of the small holding part 9.

A reason for it consists in the fact that much difference in two diameters make the bolt-screw releasing space 20 formed in it to be much narrow.

Due to this fact, a reason for it consists in a possibility that the diameter of the bolt-screw that can be released into it can be correspondingly reduced and in the case that a diameter of the bolt-screw to be used is larger than that of the bolt-screw releasing space 20 to be used, the bolt-screw is not entered.

In addition, the coil spring 26 installed in the inner space formed between the upper part of the outer socket A and the upper part of the inner socket C so as to bias the inner socket C in a direction for pushing out.

At that time, the upper part of the inner space of the outer socket A and the upper part of the inner socket C are provided with spring end fitting steps 13a, 15a, both ends of the coil spring 26 are fitted on and fixed in such a way that the center of the coil spring 26 is coincidence with the center of the outer socket A.

In this form of two sockets, the small-sized bolt head N1 is fitted on the small holding part 9 of the inner socket C and can be used, the large bolt head N3 is fitted on the large holding part 5 and can be used, that is, one tool can be used to two types of bolt heads or nuts with different sizes.

Then, if the anti-slip irregular surface 3 at the upper part of the outer socket A is gripped with a hand, the bolt head or nut can be slightly fastened without any handle, so that it becomes possible to perform a strong fastening of them if the handle is installed at the handle connecting part of the upper part.

Then, a form of three sockets will be described as follows:

The form of the three sockets is one in which another more one socket is held between the outer socket A and the inner socket C and arranged in respect to the form of the aforesaid form of two sockets.

As shown in FIG. 2, this form is constituted in such a way that the intermediate socket B is arrange between the outer socket A as being larger than the intermediate socket B and the inner socket C as being smaller than the intermediate socket B, under its constitution combination of the outer socket A and the inner socket C.

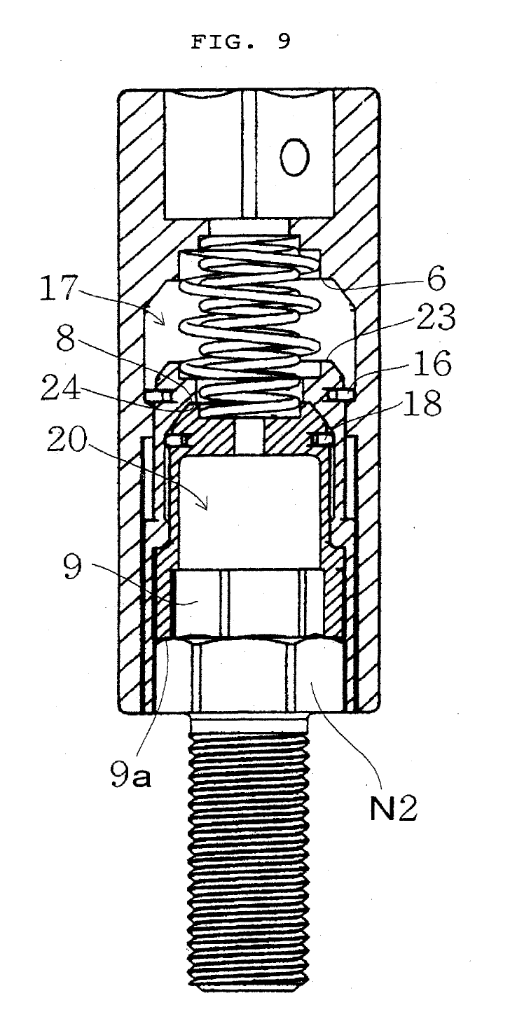

The form of the three sockets is used for turning three types of sizes, i.e., the large-sized bolt head N3 shown in FIG. 10, the medium-sized bolt head N2 shown in FIG. 9 and the small-sized bolt head N1 shown in FIG. 8.

The outer socket A forms the cylindrical hanging-bell shape and its upper part is provided with the handle connecting part. FIG. 2 shows a state in which a wrench handle connecting part is applied as the handle connecting hole 2. Thus, the anti-slip irregular surface 3 is formed around the outer side surface at the upper part of the outer socket A.

Then, as shown in FIG. 5, the entire bolt-nut turning multi socket of this invention is constituted by the cylindrical hanging-bell shaped intermediate socket B stored in the outer socket A, the cylindrical hanging-bell shaped inner socket C stored in the intermediate socket B, the coil spring 25 is installed between the outer socket A and the intermediate socket B so as to bias in a direction for pushing out the intermediate socket B from the outer socket A, the coil spring 26 is installed between the outer socket A and the inner socket C so as to bias in a direction for pushing out the inner socket C from the outer socket A, and the small diameter coil spring 26 is longer than the large diameter coil spring 25.

As shown FIG. 2, FIG. 3 and FIG. 5, the outer socket A has its inner space ranging from the opened lower part to the closed upper part with the cylindrical hanging-bell shape.

In the inner space, the polygonal sliding inner peripheral surface 4 having the polygonal cylindrical large holding part 5 at the opening end 5a side to which the large-sized bolt head or nut can be fitted on is formed from the opening part to the part near the intermediate part, the sliding inner peripheral surface 31 having the same diameter or drawn to the smaller diameter than that of the inscribed circle line-R of the polygonal sliding inner peripheral surface 4 is formed at the intermediate part, and the ring sliding inner peripheral surface 17 having the larger diameter than that of the sliding inner peripheral surface 31 is formed from the part near the intermediate part to the upper part.

At the outer peripheral surface of the intermediate socket B, the polygonal sliding outer peripheral surface 21 that is slidably inscribed with the polygonal sliding inner peripheral surface 4 in the outer socket A is formed from the lower part to the intermediate part, the sliding outer peripheral surface 29 that is slidably inscribed with the sliding inner peripheral surface 31 of the outer socket A is, formed from the intermediate part to the upper part. Accordingly, the upward step is formed at an interface between the polygonal sliding outer peripheral surface 21 and the sliding outer peripheral surface 29.

In addition, at the upper part, the ring fitting circle-cercumferencial groove 16a is arranged, and the C-shaped sliding ring 16 slidably abutted against the ring sliding inner peripheral surface 17 of the outer socket A is fitted on the ring fitting circle-cercumferencial groove 16a.

At the inner space of the intermediate socket B, the polygonal sliding inner peripheral surface 11 having the polygonal cylindrical intermediate holding part 7 at the opening end 7a side to which the medium-sized bolt head or nut can be fitted on is formed from the opening part to the part near the intermediate part, the sliding inner peripheral surface 32 having the same diameter or drawn to the smaller diameter than that of an inscribed circle line-r of the polygonal sliding inner peripheral surface 11 is formed at the intermediate part, the ring sliding inner peripheral surface 19 having the larger diameter than that of the sliding inner peripheral surface 32 is formed from the part near the intermediate part to the upper part, and the spring insertion through-pass hole 14 is passed through and arranged at the upper part.

At the outer peripheral surface of the inner socket C, the polygonal sliding outer peripheral surface 22 that is slidably inscribed with the polygonal sliding inner peripheral surface 11 in the intermediate socket B is formed from the lower part to the intermediate part, the sliding outer peripheral surface 30 that is slidably inscribed with the sliding inner peripheral surface 32 of the intermediate socket B is formed from the intermediate part to the upper part, the C-shaped sliding ring 18 having the ring fitting circle-cercumferencial groove 18a is arranged at the upper part and slidably abutted against the ring sliding inner peripheral surface 19 of the intermediate socket B is fitted on the ring fitting circle-cercumferencial groove 18a.

Then, in the outer socket A and the intermediate socket B, when the C-shaped sliding ring 16 slidably abutted against the ring sliding inner peripheral surface 17 is fitted on and stopped at its lower limit part against the tapered step 27a, the opening end 5a at the extremity end of the outer socket A and the opening end 7a at the extremity end of the intermediate socket B are arranged in flush with each other.

Therefore, in the intermediate socket B and the inner socket C, when the C-shaped sliding ring 18 slidably abutted against the ring sliding inner peripheral surface 19 of the outer socket A is fitted on and stopped at its lower limit part against the tapered step 28a, the opening end 7a at the extremity end of the intermediate socket B and the opening end 9a at the extremity end of the inner socket C are arranged in flush with each other.

All the aforesaid opening ends 5a, 7a and 9a are in flush to each other.

At the inner space of the inner socket C, the polygonal cylindrical small holding part 9 to which the small-sized bolt head or nut can be fitted on is formed from the opening end 9a to the intermediate part, and the bolt-screw releasing space 20 having the same diameter as or drawn to the smaller diameter than that of the inscribed circle line of the small holding part 9 is formed from the intermediate part to the upper part.

The bolt-screw releasing space 20 is a space for use in releasing the screw part of the bolt protruded out by the nut. Although it is not necessary to form its inner diameter larger than the diameter of the small holding part 9, there are various types of length, so that it is possible to form a deeper one in response to its application.

Each of oppositely facing the downward facing stopper 6 at the upper part of the inner space of the outer socket A and the upward facing stopper 23 at the upper part of the outer peripheral surface of the inner socket B, respectively formed. When the space between the downward facing stopper 6 and the upward facing stopper 23 is narrow and small, the large holding part 5 for holding the bolt head or nut is made shallow, resulting in that it is not preferable because when the unit is used, the bolt head or nut may easily be released.

Forming a space h2 between the downward facing stopper 6 and the upward facing stopper 23 to the same size as a height of the bolt head or nut applied as an item to be used is preferable for making the sufficient holding and hard fastening of the bolt head or nut with the large holding part 5 so as to push it.

At an interface between the bolt-screw releasing spaces 20 and the small holding part 9 is formed the bolt-nut stopper 10 where the set upper part of bolt head or nut abut against it and stop there.

Forming the height position of the bolt-nut stopper 10 from the opening end 9a to the same height as that of the bolt head or nut to be used is preferable for making the sufficient hold and strong fastening of the bolt head or nut with the small holding part 9, the intermediate holding part 7 and the large holding part 5.

Although the bolt-screw releasing space 20 is formed to the same diameter or drawn the smaller diameter than that of the inscribed circle line of the small holding part 9, it is preferable that its diameter is set to the same diameter as that of the inscribed circle line of the small holding part 9.

A reason for it consists in the fact that much difference in two diameters make the bolt-screw releasing space 20 formed in it to be much narrow.

Due to this fact, a reason for it consists in the possibility that the diameter of the bolt-screw that can be released into it can be correspondingly reduced and in the case that the diameter of the bolt-screw to be used is larger than that of the bolt-screw releasing space 20 to be used, the bolt-screw is not entered.

The spring insertion through-pass hole 14 passed at the upper part of the intermediate socket B is used for passing the small diameter coil spring 26 that is longer than the large diameter coil spring 25, installed between the outer socket A and the inner socket C in a vertical direction.

Each of oppositely facing the downward facing stopper 8 and the upward facing stopper 24 is arranged around each of the upper part of the intermediate socket B and the outside upper part of the inner socket C, respectively. When the space between the downward facing stopper 8 and the upward facing stopper 24 is narrow and small, the intermediate holding part 7 for holding the bolt head or nut is made shallow, resulting in that it is not preferable because when the unit is used, the bolt head or nut may easily be released.

Forming a space h3 between the downward facing stopper 8 and the upward facing stopper 24 to the same size as a height of the bolt head or nut applied as an item to be used is preferable for making the sufficient holding and hard fastening of the bolt head or nut with the large holding part 5 so as to push it.

The large diameter coil spring 25 installed in the inner space formed between the upper part of the inner space of the outer socket A and the upper part of the intermediate socket B so as to bias the intermediate socket B in a direction for pushing out.

At that time, the upper part of the inner space of the outer socket A and the upper part of the intermediate socket B are provided with spring end fitting steps 13b, 14a, both ends of the coil spring 25 are fitted on and fixed in such a way that the center of the coil spring 25 is coincidence with the center of the outer socket A.

Then, the small diameter coil spring 26 passed through the spring insertion through-pass hole 14 arranged at the intermediate socket B, installed in the inner space formed between the upper part of the inner space of the outer socket A and the upper part of the inner socket C so as to bias the inner socket C in a direction for pushing out.

At that time, the upper part of the inner space of the outer socket A and the upper part of the inner socket C are provided with spring end fitting steps 13a, 15a, both ends of the coil spring 26 are fitted on and fixed in such a way that the center of the coil spring 26 is coincidence with the center of the outer socket A, and the small diameter coil spring 26 is passed in the large diameter coil spring 25 and installed in the outer socket A and the inner socket C.

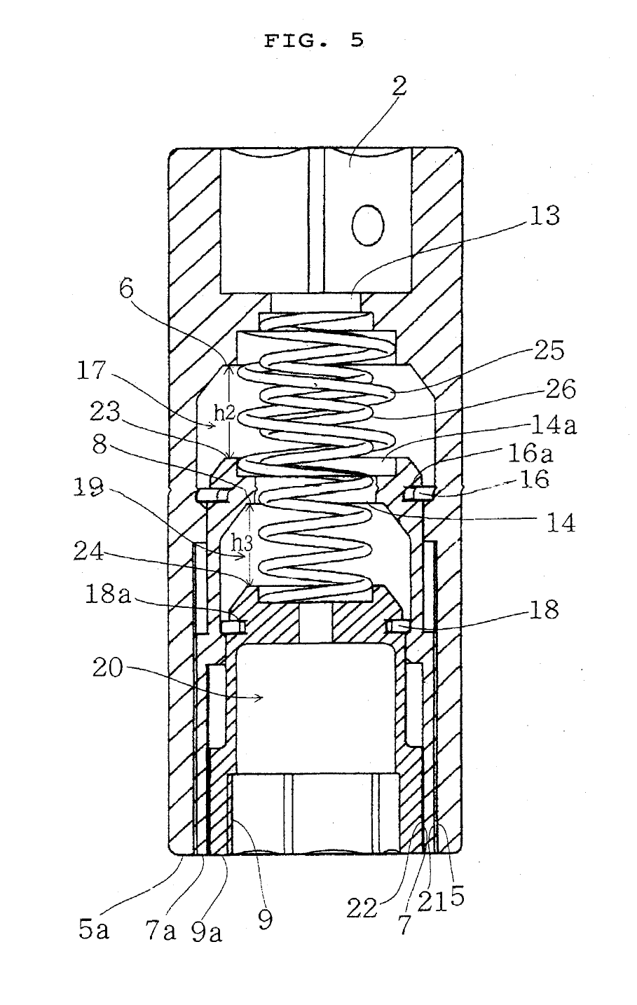

Reference numerals 33, 34, 35, shown in FIG. 4, are the corner scraping parts 33, 34, 35 respectively for use in scraping the corners of six surfaces of the opening end 5a of the large holding part 5, the opening end 7a of the intermediate holding part 7 and the opening end 9a of the small holding part 9 to cause the bolt head or nut to be smoothly entered.

In this form of three sockets, the inner socket C is kept as it is, the small-sized bolt head N1 can be fitted on the small holding part 9 and can be used as shown in FIG. 5 and FIG. 8;

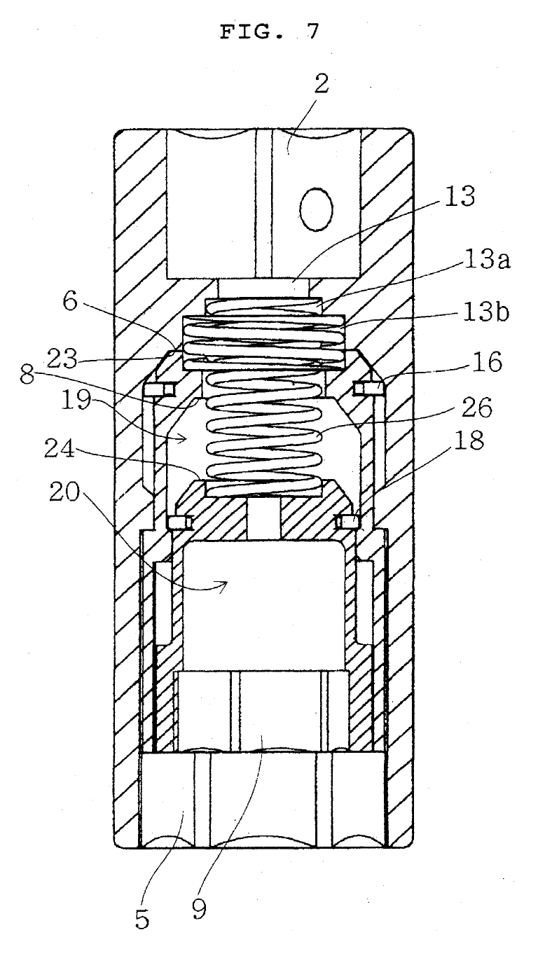

Thus, the medium-sized bolt head N2 is pressed down by the opening end 9a of the small holding part 9 to sink the small holding part 9 of the inner socket C and the medium-sized bolt head N2 can be fitted on the intermediate holding part 7 and can be used as shown in FIG. 6 and FIG. 9;

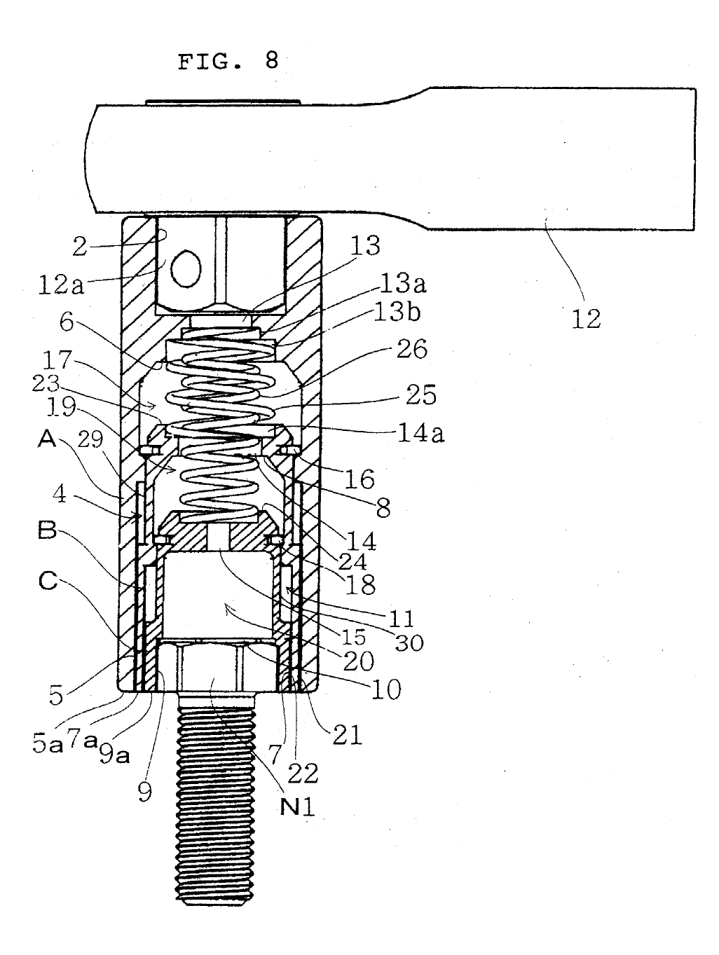

therefore, the large-sized bolt head N3 is press down by the opening end 7a of the intermediate holding part 7 of the intermediate socket B to sink the intermediate holding part 7 of the intermediate socket B together with the inner socket C and the large-sized bolt head N3 can be fitted on the large holding part 5 and can be used as shown in FIG. 7 and FIG. 10.

That is, it becomes possible to perform an easy usage of this unit in regard to the bolts head or nuts of three different sizes as described above.

Also in this type of three sockets, the unit having the anti-slip irregular surface 3 at the upper part of the outer socket A enables the bolt head or nut to be lightly fastened even if no handle is present in the same manner as that of the two sockets, and if the handle connecting protrusion 12a of the handle 12 of a torque wrench is installed at the handle connecting hole 2 of the upper part as shown in FIG. 8, a strong fastening can be carried out.

As shown in FIG. 2, in the form of the three sockets, the unit is installed between each of the sockets in such a way that the helical direction of the large diameter coil spring 25 and the helical direction of the small diameter coil spring 26 in the coil spring 25 may become inverse direction alternatively.

Under this form, the coil spring 26 of inner side and the coil spring 25 of outer side are not overlapped in their parallel relation when they are used for the medium-sized bolt head or nut, the coil spring 26 is shrunk and they are crossed to each other at their midway portions, so that a possibility that they are bitten to each other is eliminated.

Due to this fact, it becomes possible to sink positively the inner side socket into the outer socket A.

In FIG. 2, the spring end fitting step 13a, 15a and the spring end fitting step 13b, 14a arranged in a vertical direction near each of the tool insertion through-pass hole 13 of the outer socket A, the spring insertion through-pass hole 14 of the intermediate socket Band the air releasing through-pass hole 15 of the inner socket C is a circular step having a diameter substantially equal to the outer diameter of the coil arranged to restrict the end part of each of the coil springs 25, 26 to the central position of the socket.

Then, the small holding part 9 of the inner socket C contacting with the large holding part 5 of the outer socket A in respect to the large holding part having polygonal cylindrical shape corresponding to the polygonal outer peripheral shape of each size of the bolt head or nut, are formed at the position where the phase is shifted in such the direction as one where the contacted position of the bolt head or the nut has the wall thickness when the outer socket is turned in the fastening direction from the position where relative phase difference is zero.

Or, the intermediate holding part 7 of the intermediate socket B in respect to the large holding part 5 of the outer socket A, and the small holding part 9 of the inner socket C in respect to the intermediate holding part, are formed at the position where the phase is shifted in such the direction as one where a contacted position of the bolt head or nut has the wall thickness when the outer socket is turned in the fastening direction from the position where relative phase difference is zero.

In the case that the tool is turned in a clockwise direction to fasten the bolt head or nut, for example, as shown in FIG. 3 and FIG. 4, the intermediate holding part 7 is set to a position where its phase is displaced little by little with an angle β in a peripheral direction around a common central axis of the large holding part 5 corresponding to a shape of a large-sized hexagonal bolt head or nut, and further the small holding part 9 is set to a position where its phase is displaced by an angle α in its peripheral direction in respect to the intermediate holding part 7 (in respect to the large holding part 5, its phase is displaced in a peripheral direction by an angle of α+β).

Further, FIG. 4 shows an arrangement in which the holding parts are installed at a position where its phase is displaced in a counter-clockwise direction as seen from below.

In this form, each of wall thickness portions is formed at a position slightly displaced from a corner part of each of the holding parts in a slight clockwise direction, respectively, the wall thickness portions become thick to cause the tool to ensure against the strong pressure received when the bolt head or nut is fastened in a clockwise direction.

Further, under all cases, it is preferable that air releasing through-pass hole 15 are passed through and arranged at the upper central part of the outer socket A and the upper central part of the inner socket C.

The air releasing through-pass hole 15 are used for releasing air in a space to outside when the stored socket is sunk into the outer socket A.

During operation of the tool, although a space between the sockets is shrunk and when the sockets are removed, air in the space is expanded, the air can be released out of the air releasing through-pass hole 15 or entered through it, so that the air releasing through-pass hole 15 eliminates a pressurizing resistance or a pressure reducing resistance, resulting in that loading or unloading of the bolt head or nut into or out of each of the holding parts including the small holding part 9 can be smoothly carried out.

Further, since the spring insertion through-pass hole 14 is passed through and arranged at the intermediate socket B, the air releasing through-pass hole 15 is not necessary.

In addition, as shown in FIG. 2 in this invention, the tapered steps 27a, 27b, 28a, 28b to be formed at the upper and lower end parts of sliding inner peripheral surfaces 31, 32 in each of the sockets except the inner socket, and the tool insertion through-pass hole 13 is arranged at the upper central part of the outer socket A having such a caliber in which a tool can be inserted and be passed through.

In this form, the stick type tool such as a driver is inserted into the outer socket A through the tool insertion through-pass hole 13 to push out the stored socket strongly, thereby the C-shaped sliding rings 16, 18 fitted on the ring fitting circle-cercumferencial grooves 16a, 18a can move through the tapered steps 27a, 28a formed at the upper end part of the sliding inner peripheral surfaces 31, 32 of the outer side sockets while its diameter is being drawn, and can be passed through the sliding inner peripheral surface 31, 32.

Additionally, when the inner side socket is installed into the outer side socket with its hard pushing the outer side socket into the inner side socket, the C-shaped sliding ring 16, 18 can move through the tapered steps 27b, 28b formed at the lower end of the sliding inner peripheral surface 31, 32 of the outer side socket while its diameter is being drawn, and can be passed through the sliding inner peripheral surface 31, 32 and the C-shaped sliding ring 16, 18 fitted on the ring fitting circle-cercumferencial groove 16a, 18a is recovered and slidably abutted against each of the ring sliding inner peripheral surfaces 17, 19.

As the intermediate socket has the spring insertion through-pass hole 14 at its upper part, separation of all members can be carried out if the coil spring 26 is removed after the inner socket C is removed from the outer socket A, and the tool is strongly inserted at the spring insertion through-pass hole.

As described above, this invention enables three sockets for three types of sizes as well as two sockets for two types of sizes in respect to bolt heads or nuts having different sizes under application of one socket, wherein the coil spring is installed inside the socket, so that the outside part of the socket is provided with the anti-slip irregular surface 3 to enable a worker to hold the outer socket A with a hand, turn the bolt or nut and fasten them, resulting in that this invention enables a worker to adapt rapidly for an assembling work without performing a handle fixing work at a manufacturing site of various kinds of house-hold products and industrial products and so this invention can contribute remarkably to improvement of productivity.

With the foregoing, although this invention enables bolt heads or nuts of different sizes to be adapted for with one tool, there occurs a possibility that this invention can be utilized for fastening some protruded items similar to the bolts or nuts even if the protruded items do not belong to the bolts or nuts.

1. Bolt-nut turning multi socket forming a cylindrical hanging-bell shaped outer socket having a handle connecting part and/or an anti-slip irregular surface around an outer side surface formed at an upper part, having
combining form as a cylindrical hanging-bell shaped inner socket that is stored in the outer socket, or
combining form as the cylindrical hanging-bell shaped inner socket is stored in a cylindrical hanging-bell shaped intermediate socket which are stored in the outer socket, wherein,
(A) a coil spring for biasing each of the stored sockets in its pushing-out direction out of the outer socket is installed (1) between the outer socket and the inner socket,
or (2) between the outer socket and the intermediate socket and between the outer socket and inner socket;
(B) within the inner space of the outer socket, a polygonal sliding inner peripheral surface having a polygonal cylindrical large holding part at an opening end side to which a large-sized bolt head or nut can be fitted on is formed from the opening part to a part near the intermediate part, a sliding inner peripheral surface having the same diameter or drawn to a smaller diameter than that of an inscribed circle line of the polygonal sliding inner peripheral surface is formed at the intermediate part and a ring sliding inner peripheral surface having a larger diameter than that of the sliding inner peripheral surface is formed from a part near the intermediate part to the upper part, and a horizontal downward facing stopper is formed at the upper part;
(C) at the outer peripheral surface of the intermediate socket, a polygonal sliding outer peripheral surface that is slidably inscribed with the polygonal sliding inner peripheral surface in the outer side socket is formed from the lower part to the intermediate part, the sliding outer peripheral surface that is slidably inscribed with the sliding inner peripheral surface of the outer socket is formed from the intermediate part to the upper part, a C-shaped sliding ring having the ring fitting circle-cercumferencial groove arranged at the upper part and slidably abutted against the ring sliding inner peripheral surface of the outer socket is fitted on the ring fitting circle-cercumferencial groove and at the same time a horizontal upward facing stopper oppositely facing against the downward facing stopper of the outer socket is formed;
(D) within the inner space of the intermediate socket, a polygonal sliding inner peripheral surface having a polygonal cylindrical intermediate holding part at the opening end side to which the medium-sized bolt head or nut can be fitted on is formed from the opening part to a part near the intermediate part, a sliding inner peripheral surface having the same diameter or drawn to a smaller diameter than that of an inscribed circle line of the polygonal sliding inner peripheral surface is formed at the intermediate part and a ring sliding inner peripheral surface having a larger diameter than that of the sliding inner peripheral surface is formed from a part near the intermediate part to the upper part, a spring insertion through-pass hole is passed through and arranged at the upper part, and the horizontal upward facing stopper is formed;
(E) at the outer peripheral surface of the inner socket, a polygonal sliding outer peripheral surface that is slidably inscribed with the polygonal sliding inner peripheral surface in the outer side socket is formed from the lower part to the intermediate part, the sliding outer peripheral surface that is slidably inscribed with the sliding inner peripheral surface of the outer side socket is formed from the intermediate part to the upper part, a C-shaped sliding ring having the ring fitting circle-cercumferencial groove arranged at the upper part and slidably abutted against the ring sliding inner peripheral surface of the outer side socket is fitted on the ring fitting circle-cercumferencial groove and at the same time the horizontal upward facing stopper oppositely facing against the downward facing stopper of the outer side socket is formed; and
(F) within the inner space of the inner socket, a polygonal cylindrical small holding part to which a small-sized bolt head or nut can be fitted on is formed from the opening end to the intermediate part, and a bolt-screw releasing space having the same diameter as or drawn to a smaller diameter than that of an inscribed circle line of the small holding part is formed from the intermediate part to the upper part.

2. The bolt-nut turning multi socket having polygonal cylindrical shape corresponding to a polygonal outer peripheral shape of each size of the bolt head or nut, according to claim 1, wherein,
the large holding part of the outer socket combines into,
1) the small holding part of the inner socket in respect to the large holding part of the outer socket; or
2) the intermediate holding part of the intermediate socket in respect to the large holding part of the outer socket, and the small holding part of the inner socket in respect to the intermediate holding part of the intermediate socket;
are formed at a position where a phase is shifted in such a direction as one where a contacted position of the bolt head or nut has a wall thickness when the outer socket is turned in a fastening direction from a position where relative phase difference is zero.

3. The bolt-nut turning multi socket according to claim 1, wherein the tapered steps are formed at the upper and lower end parts of the sliding inner peripheral surface in each of the socket except the inner socket, and a tool insertion through-pass hole is arranged at the upper central part of the outer socket having such a caliber in which a tool can be inserted and be passed through.

4. The bolt-nut turning multi socket according to claim 2, wherein the tapered steps are formed at the upper and lower end parts of the sliding inner peripheral surface in each of the socket except the inner socket, and a tool insertion through-pass hole is arranged at the upper central part of the outer socket having such a caliber in which a tool can be inserted and be passed through.
